(19) United States
(12) Patent Application Publication
(10) Pub. No.: US 2017/0260416 A1
(43) Pub. Date: Sep. 14, 2017

(54) High Energy Drying Method to Form a Continuous Polyhydroxyalkanoated Film

(71) Applicant: SNP, Inc., Durham, NC (US)

(72) Inventors: Margaret Kehoe Joyce, Cary, NC (US); Michael James Joyce, Cary, NC (US)

(21) Appl. No.: 15/455,395

(22) Filed: Mar. 10, 2017

Related U.S. Application Data
(60) Provisional application No. 62/307,141, filed on Mar. 11, 2016.

(51) Int. Cl. C09D 167/04; B05D 3/06

(52) U.S. Cl. CPC C09D 167/04; B05D 3/06

(57) ABSTRACT

Methods for applying a polyhydroxyalkaonate (PHA) film to a substrate. The substrate is coated with an aqueous PHA emulsion or dispersion to form a PHA coating. Photonic energy is then applied to the PHA coating on the substrate to remove solvent and melt the PHA to form a continuous film.

### RELATED APPLICATION

This application claims the benefit of U.S. Provisional Application No. 62/307,141 filed on Mar. 11, 2016, which is hereby incorporated by reference in its entirety.

### BACKGROUND

Polyhydroxyalkanoates (PHAs) are attractive biopolymers that may be useful in a variety of applications. PHA biopolymers are particularly attractive because they are derived from a renewable resource, are compostable and degradable, and can be digested anaerobically. Given these benefits, there is a strong interest in many industries for finding ways to utilize PHA biopolymers for products traditionally made from non-renewable petroleum products. Examples of PHAs include, but are not limited to, Poly(3-hydroxybutyrate) (PHB), a homopolymer of 3-hydroxybutyrate that is the best characterized member of the polyhydroxyalkanoate family, as well as PHV (polyhydroxyvalerate) and PHBV (Poly(3-hydroxybutyrate-co-3-hydroxyvalerate).

PHA polymers are thermoplastic. They are a large, highly versatile polymer family that differs in their properties depending on their chemical composition (homo- or co-polyester, contained hydroxy fatty acids). Some PHAs are similar in their material properties to polypropylene (PP) and offer good resistance to moisture and aroma barrier properties. Bugnicourt, E., et al., Polyhydroxyalkanoate (PHA): Review of synthesis, characteristics, processing and potential applications in packaging. Express Polymer Letters, 2014. 8(11): p. 791-808. For food packaging, PHAs have moisture vapor barrier properties comparable to existing food-packaging materials such as polyethylene terephthalate and polypropylene. PHA is hydrophobic and resists both water and oils, even when hot. http://bioplasticsinfo.com/polyhydroxy-alkonates/applications-of-pha-as-bioplastic/, Copyright© 2014 Bioplastics Information, accessed Mar. 3, 2017.

PHA biopolymers provide barrier properties comparable to polyethylene. It has further been shown that PHA coatings are compatible with the re-pulping operations commonly used to recycle paper and corrugated cardboard. As such, one area where biodegradable PHA biopolymers may be of interest is with regard to latex coatings. As used herein, latex and latex coatings refer to PHA emulsions or dispersions. One non-limiting example of such a latex is an aqueous suspension of polymer particles that are prevented from subsequent agglomeration through use of a colloid stabilizer system that may comprise anionic, cationic, non-ionic, or polymeric dispersant types or mixtures thereof.

The need for biodegradable coatings made from renewable materials is due to the current desire for sustainable products. In addition to price considerations, this desire has resulted from the realization that remaining oil resources are becoming less accessible. Biopolymers offer an alternative to oil-based products. With regards to biodegradable coatings, however, these polymers face challenges. One challenge limiting the utilization of PHA biopolymers in biodegradable coatings arises from the cost and efficiency of forming the films necessary for proper coating.

Film formation arises from the melting of individual particles normally held apart by stabilizing forces. As used herein, melting includes melting processes and interdiffusing processes. These forces can be overcome by the removal of the continuous phase (for example, water in an aqueous system) to bring the particles into close contact, followed by subsequent melting and flow of the melted polymer to create a continuous film. A precondition of barrier properties is a continuous and pinhole free film.

Numerous theories for film formation have been reported. One such exemplar method includes a first stage of distributing the coating particles in the coating layer. Barrier coatings can be applied and metered by many different processes. Examples of such coating methods include, but are not limited to, rod, blade, flooded nip size and metered size presses, and curtain, air knife, and gravure and flexo coaters. Coating can be done in-line with the paper machine (on-line), or in a subsequent process off the paper machine (off-line). It is common for papermakers to market their paper and/or board products to printers or converters who will apply single or multiple barrier coating layers to meet the end-use requirements of their customers.

In the second stage of drying, the solids content increases resulting in the flocculation of the particles. As the drying process continues, there is an additional loss of water from the continuous phase. The interfacial tension at the water-air interface between the particles increases which pulls the particles into close contact with each other. They then condense and begin to deform. As the particles deform, the air spaces between the particles are lost as the polymer chains inter-diffuse to form a continuous film. The formation of a continuous film is dependent on the rate of drying and the minimum film formation temperature (MFFT) of the polymer. The MFFT is related to the glass transition temperature, T_{g}, or to the melting point, Tₘ of the polymer.

Regardless of the coating method used, the coated films need to be dried at sufficient temperature and for adequate time to assure that a continuous film is formed. The amount of drying energy required to form a continuous film depends upon the amount of moisture that needs to be removed, the amount of time available to remove it, and the MFFT of the coating, which depends on the T_{g} or Tₘ of the coating. The higher the basis weight of the substrate, or the higher the coat weight, or the lower the coating solids, and the faster the machine speed, the more energy required to dry the sheet and attain continuous film formation. The T_{g} and Tₘ of a polymer depend on the composition of the polymer and other factors such as degree of crystallinity, degree of crosslinking and molecular weight. Relatively strong intermolecular forces in semi-crystalline polymers prevent softening even above the glass transition temperature. Their elastic modulus changes significantly only at a high (melting) temperature. G. W. Ehrenstein; Richard P. Theriault (2001). Polymeric materials: structure, properties, applications. Hanser Verlag. pp. 67-78. ISBN 1-56990-310-7.

Commonly used drying systems for coated and/or printed paper and board all function by applying heat energy to assist in removing the continuous phase (water in the case of aqueous PHA dispersions) from the applied coating. The mass transfer of water from the base sheet and coating takes place simultaneously with the heat transfer process.

Heat transfer is defined as the energy in transition due to a temperature difference. During the drying process, the driving force for heat transfer is the temperature difference between the coated sheet and the ambient temperature in the dryer. Three basic mechanisms of heat transfer for the drying of coatings on paper or board are conduction, convection and radiation. At operating temperatures below 750° F. (400° C.), both conduction and convection are the major modes of heat transfer, while at higher temperatures the major mode of heat transfer is radiation. Examples of different drying processes that utilize these mechanisms of heat transfer are, but not limited to, steam cylinder dryers (conduction), air impingement and air flotation dryers (convection), and infrared dryers (radiation).

Mass transfer occurs as a result of the evaporation of coating moisture. As water evaporates, its mass is transported from the coating surface into the surrounding air stream. The amount of mass transfer that occurs is a function of the difference in the partial pressures between the water in the coating and in the moisture vapor in the surrounding air. The greater this difference, the higher the driving force for evaporation. Drying starts when the partial pressure of the water in the coating becomes greater than the water vapor's partial pressure in the surrounding air. This occurs when there is sufficient heat energy applied to maintain the differential pressure to create the driving force for evaporation.

With traditional drying processes, PHA biopolymer coatings require long dry times and/or high heat to reach continuous film formation to obtain desirable barrier properties. This renders PHA biopolymer coatings unattractive. While drying time can be reduced by raising the temperature within a dryer, for many of the common substrates used by papermakers and printers, the substrates on which they are applied are limited to how much heat they can receive due to such adverse effects as distortion, burning, yellowing, blistering, etc. that increase as the temperature increases. For example, a drying temperature of 10 minutes at 170° C. has been reported to enable the continuous film formation of PHA particles on Kraft paper, while a lower temperature drying of 122° C. for ten minutes was found to not result in continuous film formation. Continuous film formation and absence of pin holes are needed for optimum barrier performance.

Further, due to the extended drying times required to transform the particles into a continuous film, the application of PHA dispersions is greatly limited due to the high cost of lost productivity as a result of slowing process throughput to increase residence time. For example, a drying time of 10 minutes at a temperature of 155° C. is needed for the PHA particles to form a continuous film. If that same sample was treated with a drying time of 10 minutes at a temperature of 122° C., the result would be an incomplete melting of PHA particles.

If the drying time required for continuous film formation could be reduced, PHA suspensions could be utilized with alternative application techniques, thinner coatings, and freedom for the formulator to produce an optimized product. There is a need, therefore, to develop a high energy process to quickly form PHA films from solution processable PHA coatings on substrates such as paper and film.

### SUMMARY

The present application relates to a method for the manufacture of polyhydroxyalkonate (PHA) barrier coatings on paper and paperboard. The method is especially suitable for applications where PHA coatings cannot be dried at sufficient speeds suitable for commercial processing by paper makers, printers or converters in order for adequate film formation of the PHA particles to produce desired barrier properties, such as, for example, water resistance, oil and grease resistance, or adhesion properties desired for paper and board packaging applications. Other example barrier properties include, but are not limited to, reduced water vapor transmission, reduced oxygen transmissions, and properties that petroleum based plastics are known to impact. PHAs are biobased, biodegradable polymers that have been produced in a variety of biomass systems, such as microbial biomass (e.g., bacteria, yeast and fungi, algal biomass, and plant biomass). PHA's can be thermally processed using similar methods employed to process petroleum-based thermoplastic polymers, such as injection molding.

The present application is directed to methods for applying a polyhydroxyalkaonate (PHA) film to a substrate. The substrate is coated with an aqueous PHA emulsion or dispersion to form a PHA coating. Photonic energy is then applied to the PHA coating on the substrate to remove solvent and melt the PHA to form a continuous film.

In another embodiment, the method is directed to treating a substrate constructed from paper or paperboard. A coating that includes polyhydroxyalkonate (PHA) particles is applied to the substrate. The PHA particles are then photonically heated, which causes the PHA particles to rapidly melt to form a moisture-resistant barrier layer on the substrate.

In another embodiment, the method is directed to applying a polyhydroxyalkaonate (PHA) film to a substrate. The substrate is coated with an aqueous PHA emulsion or dispersion to form a PHA coating. Energy is applied to the PHA coating on the substrate by drying the PHA coating on the substrate and photonically heating the PHA coating on the substrate by subjecting the PHA coating on the substrate to high intensity pulses of light from a xenon flash lamp. Solvent is removed and the PHA melts to form a continuous film on the substrate.

The various aspects of the various embodiments may be used alone or in any combination, as is desired.

### BRIEF DESCRIPTION OF THE DRAWINGS

FIG. 1 is a drawing of one exemplar embodiment showing how to practice the methods described herein.

FIG. 2 is a drawing of a second exemplar embodiment showing how to practice the methods described herein.

FIG. 3 is a drawing of a third exemplar embodiment showing how to practice the methods herein.

FIG. 4 is a drawing of a fourth exemplar embodiment showing how to practice the methods described herein.

### DETAILED DESCRIPTION

The present application is directed to methods for forming a continuous PHA film. Exemplar applications for PHA polymers include non-woven fibers, injection molded utensils and thermoformed trays, all of which involve the melting and processing of PHA resin particles. Processing temperatures and pressures depend on the physical and chemical properties of the resin used.

One processing route for PHA materials is the conversion of the non-water soluble polymer into an aqueous PHA emulsion or dispersion. As used herein, PHA emulsions and dispersions contain PHA(s), and may or may not contain additional non-PHA constituents. The benefit of these materials over solid resin particles is that they can be applied as solutions in such applications as paper and architectural coatings, and binders for paints and inks where the properties of PHA films are beneficial, such as water resistance, oil and grease resistance, moisture-vapor resistance, UV resistance and high surface energies that can benefit wetting and adhesion.

In the case of paper coatings and inks, however, the substrates to which they are applied cannot withstand the temperatures required by existing drying equipment to induce PHA film formation while maintaining or achieving product throughput. A technology capable of meeting the energy input necessary to achieve PHA films is a photonic energy emitter. Unlike conventional drying systems, a photonic energy emitting unit enables the rapid heating and drying of surface layers without adversely impacting the optical or physical properties of the coating or subsurface carrier layer.

In addition to needing energy to drive off water to bring the particles in close contact with one another, energy is also needed to sufficiently raise the temperature of the PHA particles to where they melt and flow to form a continuous film. Not only is heat required to raise the temperature of the solid to the melting point, but the melting itself requires heat called the heat of fusion. The force of attraction between the molecules within the PHA polymer affects the melting point of the PHA. Stronger intermolecular interactions result in higher melting points. PHAs, through diversity of structure and chemistry, have enabled a wide range of PHA polymers of varying melting temperatures (Tₘ) and glass transition temperatures (T_{g}) to be produced.

To calculate the total drying energy required to dry a coated paper, the evaporative and sensitive heat loads for the water, coating, and paper must be determined and added. The sensible heat load can be calculated from the following equation:

Q_{S}WT/RM×S×60×SH×(T₂−T₁)
Where,
Q_{S}=Sensible heat load=Energy per foot of width (Btu/hr-ft)
WT=Basis weight (dry) of paper (lb/ream)
RM=Ream size (ft²)
S=Production speed (ft/min)
SH=Specific heat of substance (Btu/lb-ft° F.)
T₁=Sheet temperature entering the dryer (° F.)
T₂=Sheet temperature exiting the dryer (° F.)
QST=Total sensible heat load=Qₚₐₚₑᵣ+Q_{moisture in paper}+Q_{coating solids}+Q_{water in coating}
The evaporative heat load is calculated as follows:

Ev=CW/RM×S×60×(R₁−R₂)
Where,
CW=Weight of PHA coating applied (lb)
RM=Ream size (ft²)
S=Production speed (ft/min)
R₁=ratio of water to solids entering the dryer
R₂=ratio of water to solids exiting the dryer
The amount of energy to evaporate the water is then found using the following:

Q_{EV}=Ev×(1000 BTU/lb)
The total energy needed to dry the sheet is the sum of Q_{ST}+Q_{EV}

From the above equations, it is evident how the coating, substrate, and processing conditions impact the amount of energy required to dry an applied wet film. As used herein, a substrate includes any surface on which a film can be formed. Popular substrates include, but are not limited to, paper and paperboard. In order to form a continuous PHA film on a substrate, in addition to removing water, energy is also needed to melt the PHA particles. As shown by the equations provided, this is accomplished by heating both the coating and substrate to uniform elevated temperatures beyond the maximum temperature suitable for substrate use.

In the process described herein, PHA films are formed from a PHA coating, preferably an aqueous PHA coating, significantly faster than what is currently possible with conduction, convection or infrared type dryers.

The process comprises a xenon flash lamp that delivers a high intensity, short duration, pulse of light to dry and melt the PHA particles. Photonic sintering is also known as pulsed thermal processing (PTP) and intense pulsed light (IPL) processing. By way of example, NovaCentrix's™ PulseForge® 3200 and Xenon™ Corporation's S5100 are each applicable pulsed light systems that use xenon lamp photonic energy and that may be utilized with these inventions.

The main difference between the photonic and conventional drying processes is that IPL emits a short pulse of high intensity energy in such a way as to prevent thermal equilibrium between particles and substrate from being achieved. As a result, a PHA coating can be rapidly heated to much higher temperatures than possible using a conventional drying process. The higher temperatures achieved with IPL enables the PHA particles to form a film much faster and subsequently cool before any substantial heat transfer to the paper substrate can cause adverse heat effects. Even more importantly, rather than spending long dwell times in an oven or having to invest in additional driers which take up valuable floor space and are costly, this method can dry PHA coatings and melt PHA particles in time periods on the order of microseconds or shorter. With this technology, a coating can be processed at temperatures beyond the melting point(s) of PHA(s) on the surface of a paper or film without damaging it.

It is understood that a continuous PHA film can be obtained by heating a dried PHA latex coating layer to 10-50° C. above the highest Tₘ of the PHA polymer for a period of 0.1-5 seconds. (It is noted that some PHA materials have multiple polymer constituents that may have different melting points).

The present methods may use photonic energy alone for the rapid film formation of the PHA particles. Alternatively, the methods may use photonic energy in combination with other drying methods. These methods may initially apply one or more different conventional drying methods followed by photonic energy. The method may also include one or more different conventional drying methods followed by applying photonic energy. One specific method includes IR drying followed by applying photonic energy. Another method includes convection hot air drying followed by applying photonic energy. Still another method includes conduction drying followed by applying photonic energy.

The photonic energy can be applied in different manners. This may include applying the photonic energy using high frequency—low energy pulses. This may also include using low frequency—high energy pulses. Further, the application of the photonic energy may use various combinations.

The amount of photonic energy required to form a continuous PHA film depends on the amount of photonic energy absorbed by the coating and substrate and the amount of solvent (for example, in some embodiments, water) needed to be removed. Coatings and substrates that efficiently absorb photonic energy will require less energy to be applied to obtain a continuous film. Regardless of processing speed, the amount of IPL energy required to be applied and absorbed for a given coating-substrate pairing must be maintained to obtain the same desired coating properties. For IPL drying, the amount of energy is maintained at higher processing speeds by making changes to the physical components within the intensive pulse light unit such as increasing the number of lamps, adding a cooling system (to increase the ability to cool down the lamps), and changes in the actual lamps themselves.

The present methods of using IPL for the rapid film formation of PHA coatings can be applied to a variety of different substrates. These substrates include but are not limited to paper and paperboard products, particularly those used for the packaging, wrapping, baking; or transport of cheese, frozen foods, produce, meats, and high oil content foods such as peanut-containing products and baked goods. The substrates may also include cups and lids (due to its water resistance), high bio-content compostable bags, and corrugated boxes used for the shipping of produce, poultry and meats.

In addition to paper and paperboard substrates, the present methods may also be used to rapidly form PHA films on low temperature plastic and bioplastic films.

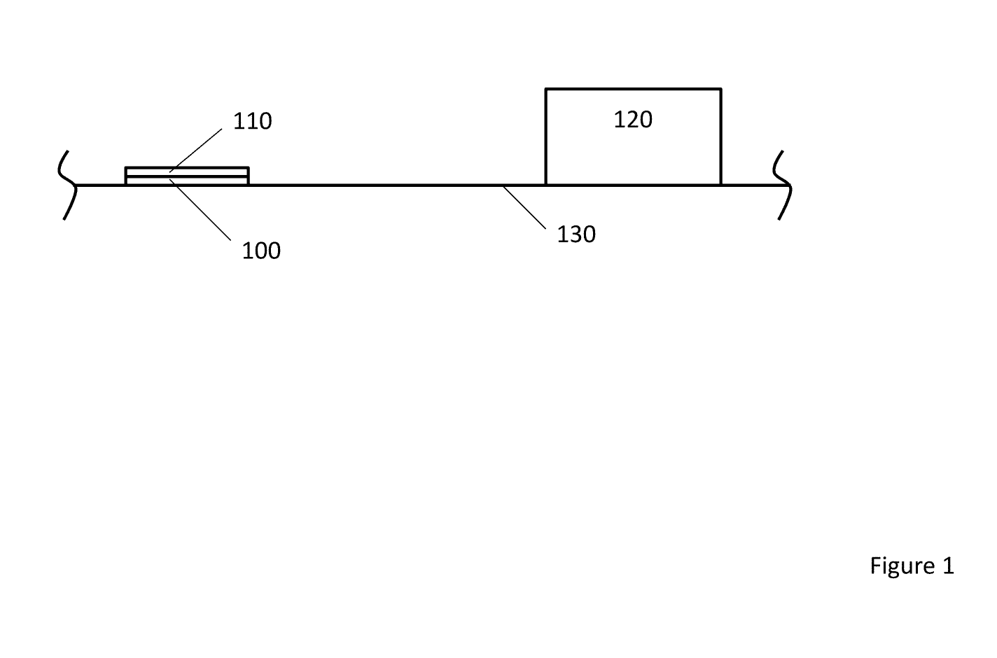

FIG. 1 schematically illustrates one exemplar process of treating a substrate 100. The substrate 100 is initially coated with a dispersion of PHA particles 110. The coating 110 covers a limited section of the substrate 100, such as along one side or a limited section of one side, or may cover an entirety of the substrate 100. In one embodiment, the PHA particle dispersion applied as a liquid may be applied through various methods. In other embodiments, the PHA particle dispersion may be applied as a solid or as a semi-solid.

Photonic energy is then applied to the coated substrate 100. In one embodiment, the coated substrate 100 is moved past a photonic device 120. Other embodiments may include the photonic energy source being moved to treat the substrate. FIG. 1 includes an embodiment with the coated substrate 100 being moved along a conveyor 130 and past the photonic device 120.

The photonic device 120 may include various configurations, such as a flash lamp or an arc lamp that emits photonic energy (e.g. pulsed light) at various frequencies and energy levels. The photonic energy speeds the drying of the coating 110, thus making the process more applicable for commercial applications. The photonic energy further causes a continuous PHA film to produce a barrier that has water resistance and oil and grease resistance. Further, the use of the photonic device provides for the drying and/or melting of the coating and film formation of the PHA particles without adverse thermal coating or substrate effects.

The present application relates to a process for the manufacture of polyhydroxyalkonate (PHA) barrier coatings for paper and paperboard. The method is especially suitable for applications where PHA dispersions or coatings cannot be elevated to a sufficient temperature to form a continuous PHA film at sufficient speeds suitable for commercial processing by paper makers, printers or converters in order for the PHA particles to produce the water resistance and oil and grease resistance barrier properties desired for paper and board packaging applications. The PHA can be dried and melted with a photonic energy emitting unit. Unlike conventional drying systems, a photonic energy emitting unit enables the rapid heating and drying of surface layers without adversely impacting the optical or physical properties of the coating or subsurface carrier layer.

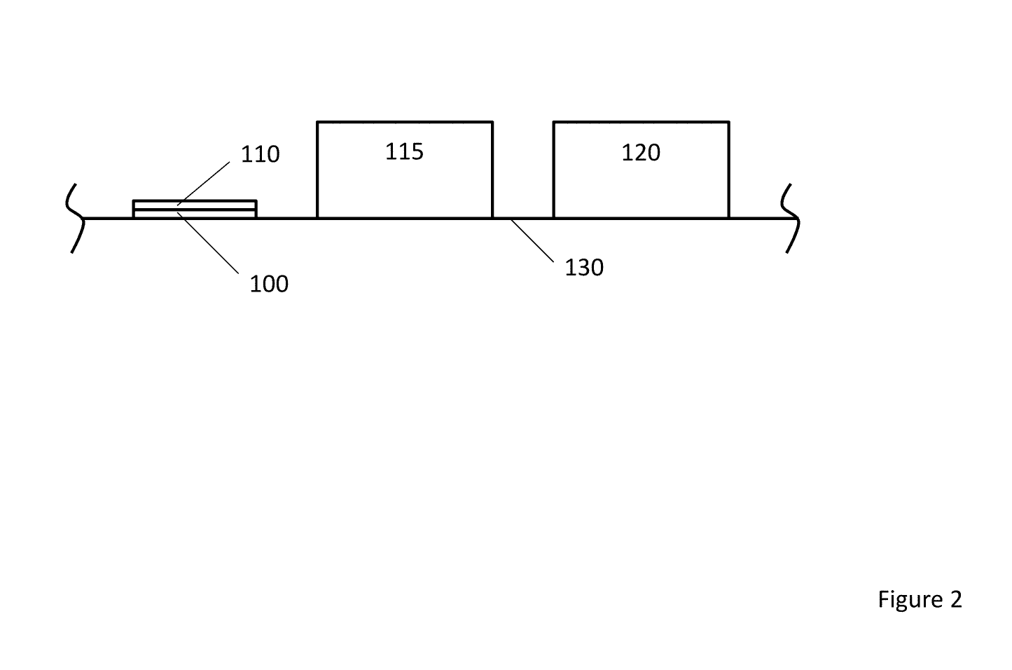

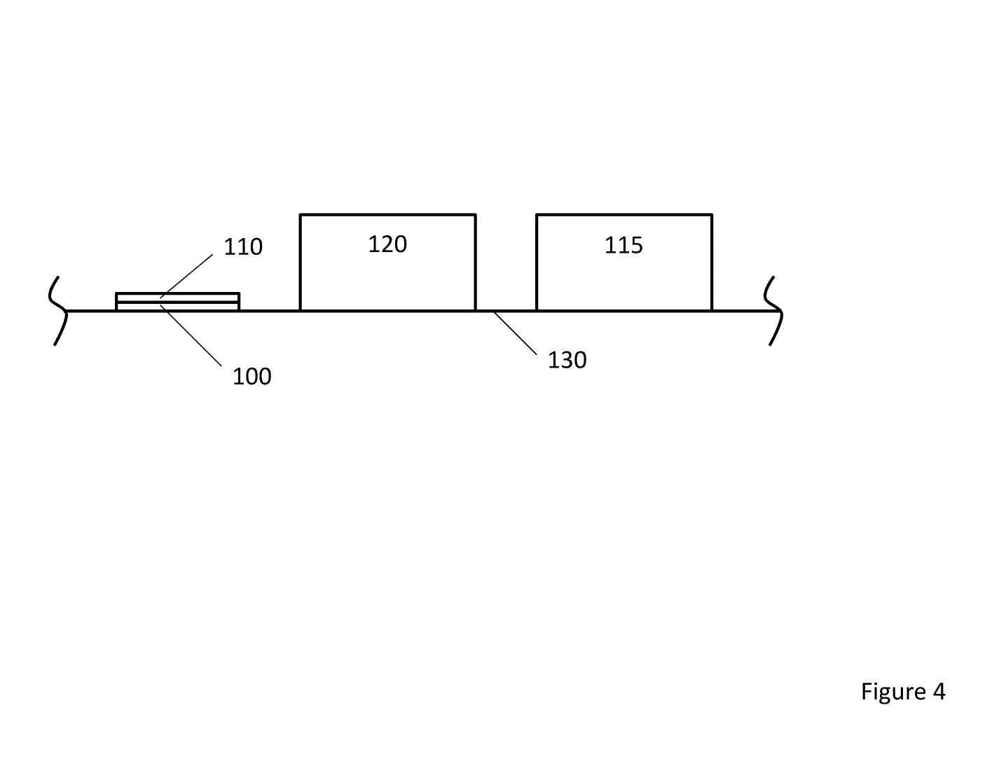

The process may also include further drying by another drying device. FIG. 2 illustrates one embodiment with a drying device 115 positioned along the conveyor 130. Before the coated substrate 100 is treated with photonic energy at the photonic device 120, the substrate 100 is first treated with the drying device 115. The drying device 115 may provide for a variety of different drying techniques through heat transfer, such as through conduction, convection, and infrared. FIG. 2 includes an embodiment with the drying device 115 treating the coated substrate 100 before the photonic device 120. Other processes may include the drying device 115 treating the coated substrate 100 after the photonic device 120, which is depicted on FIG. 4.

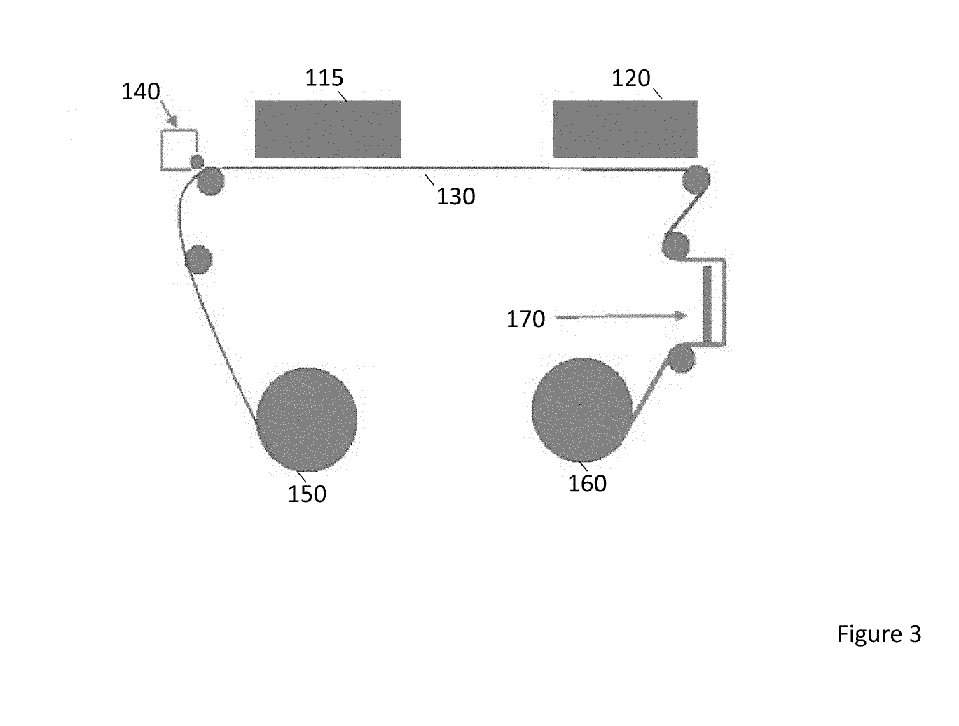

FIG. 3 shows another embodiment. A substrate is directed along belt 130. Belt 130 includes an unwind reel 150, a wind up reel 160, and a tension guide 170. The substrate is directed through a rod or flexo coater 140, then dried in a drying device 115, and heat treated in a photonic device 120.

By utilizing the methods described herein, it is possible to incorporate PHA coatings into industrial processes for paper and paperboard. For example, the methods herein allow for paperboard and paper processes to continue to operate at the same speeds as traditional, non-renewable coating, such as, for example 1000 ft/min for paperboard and 4,000 ft/min for paper.

### EXAMPLES

An aqueous PHA coating (Mirel™ 8000 latex) supplied by Metabolix®, Cambridge, Mass., was applied to 3 different substrates. The substrates tested were a 165 gsm bleached Kraft paper, 73 gsm unbleached Kraft liner, and a 54 gsm bleached Kraft machine glazed paper. Coatings were applied to the basepapers using various Meyer rods to obtain coat weights ranging from approximately 5 to 38 gsm. After coating, samples were dried by two different methods:
1) in a forced air drying oven at 155° C. for ten minutes; and
2) IPL using a Novacentrix™ PulseForge® emitting 14.8 J/cm².

The number of passes was varied from 1-3 passes/sample. After drying, the oil and grease resistance of the coated samples was measured using the 3M Kit test in accordance with TAPPI standard test method T-559, see Table 1. The oil and grease barrier resistance results for the photonically treated samples are in agreement with our oven dried results and those found for the oven dried treated samples produced in this work.

SEM pictures of the IPL treated 165 gsm and 54 gsm papers coated with 14.7 gsm PHA (3 pass and 2 passes respectively), demonstrated that the PHA particles are completely melted. The lamp to platen was set to 15 mm below the window. The waveform parameters used were a single pulse, bank voltage 450V, pulse duration 10,000 μs, fixed position mode and fire rate of 1.0 Hz. The above settings provided an energy of 14.8 J/cm². The coated surface was similar to what was observed for the 155° C., 10 min oven dried treatment at similar magnifications (approx. 5000×).

TABLE 1
Comparison of Kit Tests

| | Coat weight | | | | |
|---|---|---|---|---|---|
| | (gsm) | | | Oven Temperature | |
| Oven Dried Sample | 4.4 | 16.2 | 19.6 | and Time | |
| Kit Value for 165 gsm BK | 0 | 12 | 12 | 155° C. 10 min | |
| Kit Value for 73 gsm UBK liner | 0 | 9 | 10 | 155° C. 10 min | |
| Kit Value for 54 gsm BK | 12 | 12 | 12 | 155° C. 10 min | |
| | Coat weight | | | | |
| | (gsm) | | | Passes (#) Under | |
| Photonic Dried Sample | 5.7 | 14.7 | 25.3 | IPL | |
| Kit value for 165 gsm BK | 0 | 12 | 12 | 3 | passes |
| Kit value for 73 gsm UBK liner | 0 | 9 | 9 | 2 | Pass |
| Kit Value for 54 gsm BK | 12 | 12 | 12 | 1 | pass |

In a second study, the same aqueous PHA coating (Mirel™ 8000 latex) supplied by Metabolix®, Cambridge, Mass., was applied to a continuous web and metered with a wire wound Meyer rod. The physical properties of the material as reported by the supplier are shown in Table 2.

TABLE 2
PHA coating properties

| Crystallinity | Semi-crystalline | |
|---|---|---|
| Solids | 55% | |
| Particle size, D50 | 1-3 | microns |
| Viscosity | 300-500 | Cps |
| Tₘ | 130-180° | C. |

The substrates used and coat weights applied are shown in Table 3. For the substrate, three different energy treatments were applied; Infrared (IR) only, Intensive Pulse Light (IPL), and IR+IPL. In addition to applying these treatments, coated papers receiving no treatment were oven dried at 155° C. for 10 min. A schematic of the equipment used (NovaCentrix™, Austin Tex.) to coat and treat the papers is provided in FIG. 3.

TABLE 3
Summary of Test conditions

| | Caliper | Basis Wt. | Coat Weight |
|---|---|---|---|
| Substrate | (microns) | (g/m²) | (g/m²) |
| Unbleached | 114 | 91 | 17 |
| Kraft | | | |
| Bleached | 49 | 38 | 15 |
| Kraft | | | |
| Bleached | 32 | 24 | 16 |
| Kraft | | | |
| Unbleached | 38 | 22 | 19 |
| Kraft | | | |
| Bleached | 133 | 95 | 20 |
| Kraft | | | |

After treatment the samples were conditioned for 24 hrs according to TAPPI standard T-402 (RH 50%±2%, 23° C.±1° C.). After conditioning, coat weights were measured gravimetrically using a standard 100 cm punch and CEM Smart Turbo microwave solids analyzer. The resistance of the coated samples to the absorption of water was tested by performing 2 minute Cobb tests (gsm) in accordance with TAPPI standard test method T-441. 3M Kit testing was also performed in accordance with TAPPI standard test method T-559 to test for oil and grease resistance.

As shown in Table 4, the IR treatment failed to provide oil, grease or water resistance to any of the substrates, while both the IR+IPL and IPL treatments provided good barrier properties. The poor barrier properties for the IR treated papers are the result of incomplete PHA film forming which was evident by the color of the substrate surface. Treated substrates failing to provide barrier resistance were dull and/or chalky white, while substrates with good barrier properties were glossy and the presence of a clear film was evident.

The coating observed was clear, enabling the unbleached substrate to be clearly visible. The IR dryers were operated under maximum power of 7.5 kVA. The IPL energy required to form a continuous PHA film was found to be 6.21 J/cm² for the unbleached papers and 10.38 J/cm² for the bleached papers. The difference is due to a difference in the photonic energy absorption of the papers. Being darker in color, the photonic energy absorption of the unbleached papers was higher. The bleached papers being of much higher whiteness reflected rather than absorbed more of the photonic energy. The results in both Tables 4 and 5 show the 10 minute oven dried samples provided similar barrier properties to the IPL and IR+IPL treated samples, which were dried in 5.6 ms with no adverse heating effects. The web temperature at the wind up reel was only slightly warmer than the temperature at the unwind feed roll.

TABLE 4
Influence of Heat Treatment on Oil and Grease Resistance Barrier
Properties as measured by TAPPI Standard Test Method T-559
(12 = highest barrier resistance and 0 = no barrier resistance)

| | Treatment | | | |
|---|---|---|---|---|
| Substrate | IR | IPL | IR + IPL | Oven Dried |
| Unbleached Kraft- | 0 | 0 | 0 | 0 |
| 91gsm | | | | |
| Bleached Kraft-38 gsm | 0 | 6 | 5 | 6 |
| Bleached Kraft-24 gsm | 0 | 12 | 8 | 9 |
| Unbleached Kraft-22 | 0 | 10 | 7 | 9 |
| gsm | | | | |
| Bleached Kraft-95 gsm | 0 | 5 | 5 | 5 |

TABLE 5
Influence of Heat Treatment on Water Resistance Barrier Properties as
Measured by the 2 minute Cobb Test, gsm (0 = 100% barrier)

| Substrate, basis | Treatment | | | |
|---|---|---|---|---|
| weight | IR | IPL | IR + IPL | Oven Dried |
| Unbleached | Coating | Soaked | Soaked | Soaked |
| Kraft-91 gsm | dissolved | through | through | through |
| | | due to | due to | due to |
| | | incomplete | incomplete | incomplete |
| | | coverage | coverage | coverage |
| Bleached | Coating | 0.33 | 0.34 | 1.06 |
| Kraft-38 gsm | dissolved | | | |
| Bleached | Coating | 0.17 | 0.24 | 0.74 |
| Kraft-24 gsm | dissolved | | | |
| Unbleached | Coating | 0.24 | 0.25 | 0.83 |
| Kraft-22 gsm | dissolved | | | |
| Bleached | Coating | 0.67 | 0.69 | 2.28 |
| Kraft-95 gsm | dissolved | | | |

In yet another experiment, PHA coatings of different coat weights were applied to a 23 g/m² bleached Kraft paper by the draw down method using a #20 Meyer Rod. After coating, the samples were oven-dried at 155° C. for 10 minutes. The results of the Kit tests and 2 minute Cobb test are similar to those reported above for the 24 g/m² bleached Kraft paper from another supplier at the 16 gsm coat weight.

In yet another experiment, a PHA coating was applied to a 38 g/m² bleached Kraft paper and 95 g/m² bleached Kraft paper at 15 and 20 g/m², respectively and a 20 minute Cobb test was performed after treatment with IPL. The Cobb values for each were 1.41 gsm for the 15 gsm coating and 2.71 gsm for the 29 gsm coating, and of equivalent value to oven dried samples of the same coat weight.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A method for applying a polyhydroxyalkaonate (PHA) film to a substrate, the method comprising:
coating the substrate with an aqueous PHA emulsion or dispersion to form a PHA coating; and
applying energy to the PHA coating on the substrate by photonically heating the PHA coating on the substrate and removing solvent and melting the PHA to form a continuous film.

2. The method of claim 1, wherein photonically heating the PHA coating on the substrate comprises delivering high intensity pulses of light from a xenon flash lamp to the PHA coating on the substrate.

3. The method of claim 1, wherein applying energy to the PHA coating on the substrate further comprises drying the PHA coating on the substrate.

4. The method of claim 3, wherein drying the PHA coating on the substrate occurs prior to photonically heating the PHA coating on the substrate.

5. The method of claim 3, wherein drying the PHA coating on the substrate occurs after photonically heating the PHA coating on the substrate.

6. The method of claim 1, wherein the substrate comprises paper or paperboard.

7. A method for treating a substrate constructed from paper or paperboard comprising:
applying a coating that includes polyhydroxyalkonate (PHA) particles to the substrate;
photonically heating the PHA particles and causing the PHA particles to rapidly melt thereby forming a moisture-resistant barrier layer on the substrate.

8. The method of claim 7, further comprising moving the substrate with the PHA particles relative to a light source and photonically heating to melt the PHA particles.

9. The method of claim 7, further comprising drying the PHA particles using one of convection, conduction, and IR drying, with this additional drying occurring either before or after the photonic heating.

10. A method for applying a polyhydroxyalkaonate (PHA) film to a substrate, the method comprising:
coating the substrate with an aqueous PHA emulsion or dispersion to form a PHA coating;
applying energy to the PHA coating on the substrate by drying the PHA coating on the substrate; and
photonically heating the PHA coating on the substrate by subjecting the PHA coating on the substrate to high intensity pulses of light from a xenon flash lamp;
wherein applying energy to the PHA coating on the substrate removes solvent and melts the PHA to form a continuous film on the substrate.

11. The method of claim 10, wherein drying the PHA coating on the substrate occurs prior to photonically heating the PHA coating on the substrate.

12. The method of claim 10, wherein drying the PHA coating on the substrate occurs after photonically heating the PHA coating on the substrate.
